(19) United States
(12) Patent Application Publication
(10) Pub. No.: US 2018/0220186 A1
(43) Pub. Date: Aug. 2, 2018

(54) METHOD FOR CHANGING SERVICE OF A DIGITAL TELEVISION DECODER, AND DEVICE FOR IMPLEMENTING SUCH A METHOD

(71) Applicant: SAGEMCOM BROADBAND SAS, Rueil Malmaison (FR)

(72) Inventor: Farid BENAMROUCHE, Rueil Malmaison (FR)

(21) Appl. No.: 15/748,041

(22) PCT Filed: Jun. 30, 2016
(86) PCT No.: PCT/FR2016/051647

§ 371 Date: Jan. 26, 2018

(30) Foreign Application Priority Data
Jul. 29, 2015 (FR) 1557265

(51) Int. Cl. H04N 21/438; H04N 21/262

(52) U.S. Cl. CPC H04N 21/4384; H04N 21/26291

(57) ABSTRACT

A method for changing service of a digital television decoder, the digital television decoder receiving data in the form of a stream of signals including audio and/or video data and data for managing the audio and/or video data, an access to a service requiring the digital television decoder to acquire the management data of the service, the method including: within an electronic device of management data, automatically memorising a management list, the list including at least one first group of management data associated with a first service and a second group of management data associated with a second service; receiving in the digital television decoder a service change command in order to switch from the first service to the second service; and accessing the second service using the second group of management data stored in the electronic device.

### TECHNICAL FIELD OF THE INVENTION

The present invention relates to a method for changing service of a digital television decoder; it also relates to an electronic device suited to implementing such a method for changing service. Service is conventionally taken to mean what users call a television channel, for example a channel broadcasting programmes succeeding one another over the course of the day. However, the services may be uniquely audio services or data services or others.

The objective of the invention is to improve a zapping time when a user of a digital television decoder performs a change of service. Zapping time, or service change time, designates the time that passes between the transmission of a service change command by a user of a digital television decoder, for example by means of an appropriate remote control, and the actual display of the desired service on the screen linked to the considered decoder.

The field of the invention is, generally speaking, that of digital television decoders. For simplification, in the remainder of the document, the term “decoder” will designate a digital television decoder. In the digital television field, digital television decoders are used notably in order to access a set of television channels which are transmitted encrypted and which are de-encrypted within the decoder.

The transmission means that transmit the television transmissions to these decoders are either conventional aerial transmission means, or coaxial or even optical cables, or retransmission satellites that serve a region, or instead the Internet network. The invention finds interest for all types of decoders, whether decoders receiving a stream of signals to decode by satellite, or instead by TNT, or instead for IP decoders which receive the stream of signals to decode via the Internet network.

The decoder includes reception means for receiving the transmitted signals and formatting means for transforming the signals received into signals applicable directly on the controls of a visualisation device.

The formatting takes place by respecting parameter tables for each of the images to represent. Different types of table may be distinguished: SI (System Information) tables, PSI (Programme Specific Information) tables, NIT (Network Information Tables), EIT (Event Information Tables), PAT (Programme Associated Tables), CAT (Access Control Tables) or PMT (Programme Map Tables), etc.

In digital television, it is provided that the signals of parameters are transmitted in the stream (that is to say with the video signal itself) in data packets. Once received, the different packets are allocated to the appropriate tables. The packets of a same table are not necessarily grouped together in a same section. They can be spread out in successive sections, interlaced with information packets relative to other tables or to the video, audio, data signal or other. In each section, identifiers make it possible to allocate data packets to particular tables among others. In reception, a decoder does not know at first how the data packets are spread out but it can recognise a clipping of sections. The decoder thus has to read the identifier in each section and reorganise the data in order to assign them to the right tables. All the signals of parameters relative to the different tables are edited by the television operators, are incorporated in the stream of this operator, and are conveyed to the users by the different media.

Eventually, a whole architecture of tables is thereby distributed and the aim of the decoder is to reconstruct all the tables to have available adjustment information as well as information to show visually for the users.

In each stream of multiplexed signals transmitted, whatever the physical support used, a table known as PAT, Program Association Table, is broadcast. This table gives the list of services available in the considered stream of multiplexed signals; it thus gives the list of PMT, Program Map Tables, which are associated with each of the services, and which define, for each service, the list of components associated with this service.

For each service, access control information associated with this service is notably found in the PMT. The access control table CAT makes it possible to withdraw this information and to execute the transmission of this information to a microprocessor of the decoder, the latter then being able to determine if the user of the decoder has rights to this service. If this is the case, the microprocessor sends back appropriate information which makes it possible to obtain a digital decryption key for the considered service. The latter may then be restored in decrypted form on a visualisation screen.

### TECHNOLOGICAL BACKGROUND OF THE INVENTION

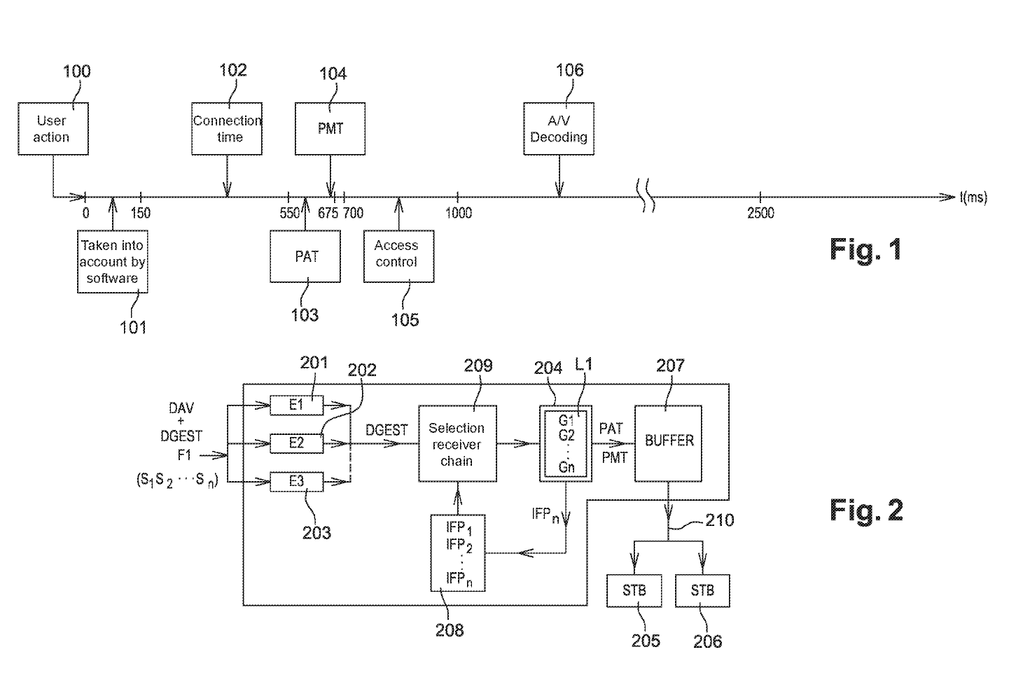

In the prior art, a simplified operation (not involving, for example, an FEC type error correction system) of zapping on a decoder follows the various steps shown in the timing diagram of FIG. 1. In this figure, the initial instant (t=0) is marked as being the instant when a user performs an action 100 to carry out a change of service. Such an action usually comprises pressing on one or more appropriate buttons of a remote control associated with the decoder. The passing of the zapping time is marked compared to this time reference.

A first step 101 then resides in the software operating the decoder taking into account the action of the user. The duration of this step is typically 150 ms (milliseconds).

A second step 102 then follows, during which the decoder executes a command, for example a command designated “command IGMP join” in the case of an IP decoder. The duration of this step is close to 400 ms; it corresponds to a connection time of the decoder, the time necessary, from the execution of the command “IGMP join”, to receive first packets of appropriate data extracted from a stream of multicasted signals. In the case of terrestrial decoders, satellites or cables, the connection time of the decoder corresponds to the time that passes between an action on the tuner of the decoder, and the actual reception of the first data packets.

An operation of storing data received in the stream in a buffer memory, with demultiplexing of the different components, is then carried out. Such an operation takes however negligible time due to the fact that the different components involved are hardware.

The different tables and parameters required to carry out the zapping operation are next acquired:

Thus, a following step 103, which typically lasts 75 ms, is a step of acquisition of the table PAT.

Then, a step 104 follows, of an average duration of 75 ms, in which the table PMT is acquired. In an unfavourable case, the acquisition of the table PMT and the table PAT may thus last up to 250 ms.

Next, in a following step 105, the access control is carried out; this lasts around 300 ms and makes it possible to check that the considered decoder indeed possesses rights to access the requested service.

Once the different parameters and tables have been acquired, the operation of audio and video decoding for the desired service is carried out in a following step 106. The time taken between the communication of the audio and video data to the audio and video decoder of the decoder and the actual display on the visualisation screen is of the order of 1500 ms.

Thus, to carry out a zapping operation in decoders of the prior art, a duration close to 2500 ms is required.

### GENERAL DESCRIPTION OF THE INVENTION

The method according to the invention proposes a solution to the problems and drawbacks that have just been described. The invention proposes a solution for reducing the zapping time by intervening at the level of the recovery of tables required to access a considered service. To this end, the invention proposes anticipating the memorisation of these tables, by memorising them in a memory module before a service change command has been received by the decoder. The considered memory module may be integrated in a decoder, and advantageously communicate the memorised data to other decoders; the memory module may also constitute an independent electronic device, placed in the premises of the user of the digital decoder, or instead in the premises of the service broadcaster.

The invention thus essentially relates to a method for changing service of a digital television decoder, said digital television decoder receiving data in the form of a stream of signals composed of a plurality of services and including audio and/or video data and data for managing said services, in which an access to a service in response to a service change command requires the digital television decoder to acquire the management data of said service, said method being characterised in that it includes the various steps that consist of:
within an electronic device of management data, memorising a management list before the request to access the service, said list including at least one first group of management data associated with a first service and a second group of management data associated with a second service;
receiving in the digital television decoder a service change command in order to switch from the first service to the second service;
accessing the second service using the second group of management data stored in the electronic device.

In the method according to the invention, the management list is thereby memorised automatically, that is to say notably without a user of the decoder intervening on said decoder, for example by means of its remote control. The method according to the invention is advantageously implemented from the moment that the memorisation module is operational, that is to say from the moment that the electronic device that integrates it, whether it is a television decoder or another device, is supplied with power and that it receives the stream of signals destined for the decoder.

The method according to the invention may include, in addition to the main steps that have just been mentioned in the preceding paragraph, one or more additional characteristics among the following:
the method includes the additional step that consist of memorising, in the management list, the totality of the management data of the stream of signals;
the method includes a step of automatic updating the management list, each memorised group of management data being replaced by an updated group of management data when a programme broadcast by the service associated with the group of management data considered changes;
the step of automatic updating the management list includes the operation that consist of memorising, for each service for which management data is memorised, an end of programme information corresponding to a schedule marking the end of the programme broadcast by the considered service at the moment of the memorisation of the management data that are associated therewith;
the module for memorising management data includes at least one first receiver chain and a second receiver chain receiving the stream of signals, the receiver chain used for the replacement of a memorised group of management data by an updated group of management data being the receiver chain having been used for such a replacement operation for the longest duration;
the module for memorising management data is arranged beforehand in the premises of a service broadcaster;
the method includes the additional step that consist of establishing an IP link, or Internet link, between the module for memorising management data and the digital television decoder to communicate the second group of management data from the module for memorising management data to the digital television decoder;
the module for memorising management data is integrated beforehand in a digital television decoder;
the method includes the additional step that consist of establishing an IP link between the digital television decoder integrating the module for memorising management data and at least one secondary digital television decoder to communicate the second group of management data from the digital television decoder integrating said memorisation module to each secondary digital television decoder.

The various additional characteristics of the method according to the invention, in so far as they are not mutually exclusive, are combined according to all association possibilities to end up with different exemplary embodiments of the invention.

The present invention also relates to an electronic device suited to being used as module for memorising management data in the method according to the invention, said device including:
automatic memorisation means in a memory module for automatically memorising a management list, said list including at least one first group of management data associated with a first service and a second group of management data associated with a second service;
means of automatic updating said management list.

The present invention finally relates to a digital television decoder characterised in that it is equipped with the electronic device according to the invention.

The invention and the applications thereof will be better understood on reading the description that follows and by examining the figures that accompany it.

### BRIEF DESCRIPTION OF THE FIGURES

These are presented for indicative purposes and in no way limit the invention. The figures show:

in FIG. 1, already described, a timing diagram illustrating the progress of a zapping sequence for a decoder receiving a stream of signals;

in FIG. 2, a functional diagram illustrating an exemplary embodiment of the method according to the invention;

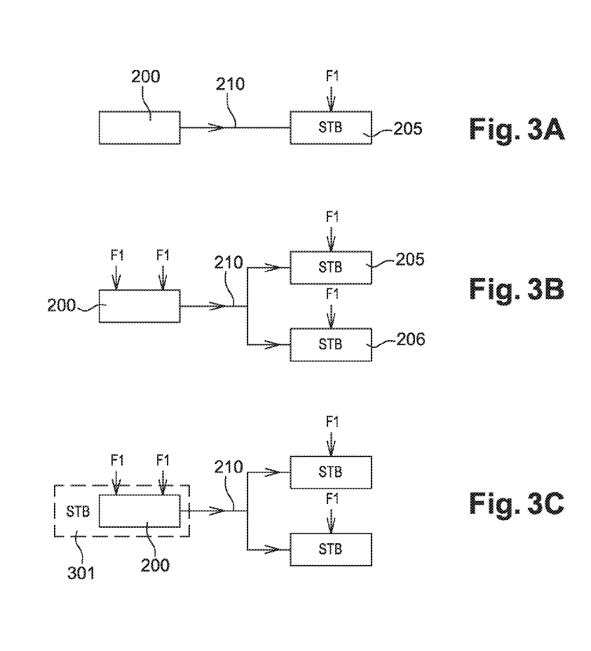

in FIGS. 3-A, 3-B and 3-C, respectively a first, a second, and a third example of configuration for using the device according to the invention.

### DESCRIPTION OF PREFERRED EMBODIMENTS OF THE INVENTION

Unless stated otherwise, the different elements appearing in several figures retain the same reference.

In the remainder of the description, the expression “management data” associated with a service, notably a television service, will designate the set of data required by the decoder to access the considered service in such a way as to restore it on a restoration means; for a considered service, these data thus comprise different tables dedicated to said service, notably PAT and PMT, which are advantageously completed by information of EIT and/or PID type including certain data, notably data relative to a time of end of a programme currently being broadcast for the considered service.

In FIG. 2 is represented an electronic device, also designated memorisation module, 200 according to the invention, used to implement the method according to the invention to carry out an operation of change of service of a decoder. The electronic device 200 may be considered as a module for memorising, and advantageously organising, management data as defined previously.

The electronic device 200 includes at least one first receiver chain 201. In the example represented, the electronic device includes three receiver chains, with a second receiver chain 202 and a third receiver chain 203. Each receiver chain 201, 202 and 203 includes an input, referenced respectively E1, E2 and E3, at the level of which a stream of signals F1, composed of a plurality of services (S1 . . . Sn) is received. The stream of signals is transmitted by an operator broadcasting services, for example television services. The stream of signals F1 thereby includes, multiplexed, audio and/or video data DAV and management data DGEST, as defined previously, of audio and/or video data DAV.

Each receiver chain includes the necessary means for receiving and processing the stream of signals F to extract therefrom the management data DGEST. Depending on the type of digital decoder considered, the receiver chains may include notably a tuner type element and/or a demultiplexer type element. Once the stream of signals F1 has been processed by one of the receiver chains, for each considered service transmitted in the stream F1, a group of management data DGEST is extracted therefrom. For example, for a first service Sn, a group of management data Gn is recovered from the stream of signals F1.

The groups of management data Gn are intended to be memorised in a memory 204 for example in the form of a management list L1. In the invention, when it is wished to carry out an operation of change of service to switch from a first service S1 to a second service S2, within a first decoder 205 and/or within a second decoder 206, the corresponding group of data G2 is used to extract therefrom at least the tables PMT and PAT associated with the service S2. A transmission 210 of these data is then carried out, for example after having transited via a buffer, or buffer memory, 207, to the appropriate decoder. The transmission is advantageously achieved by means of an Internet link. Other transmission means are possible, for example Bluetooth type wireless transmission means.

Moreover, in the invention, it is advantageously provided to consider, in each group of management data Gn, an end of programme information IFPn, typically contained in EIT type tables. The end of programme information IFPn gives an indication, for the considered service Sn, of the schedule of the end of programme currently being broadcast on the considered service.

In this way is constituted, in the example described, a list of end of programme information IFPn used by a software application 208, designated application for organising end of programme data. The software application 208 organises the list of end of programme information IFPn so as to extract from the stream F1 a new group of management data Gn corresponding to the service Sn which has been identified by the software application 208 as being the first service to present a change of programme. There is thus available, for the service Sn, an updated group of management data Gn, including an updated end of programme information IFPn.

In order to carry out the extraction of the new group of management data Gn, a software application 209 is used, designated receiver chain selection application, which selects one of the receiver chains available at the input of the electronic device 200. Advantageously, if all the receiver chains are already being used, the software application 209 uses the receiver chain carrying out the extraction of data associated with a service for the longest duration, in comparison with the extraction durations of the other receiver chains.

Thus, in the invention, there is permanently available, in the memory 204, updated groups of management data Gn which may be directly used by any decoder linked or connected to the—or incorporating the—electronic device 200.

In the case where a service does not present, in the management data that it conveys, end of programme information, the management data of this service is extracted in a regular manner, by allocating one of the receiver chains in a predefined manner, for example every ten minutes.

The various software applications involved in the method according to the invention, notably software applications for organising end of programme data 208 and selection of receiver chain 209, are managed within a programme memory, not represented, of the electronic device 200.

In FIGS. 3-A, 3-B and 3-C are represented different configurations in which the method and the device according to the invention are advantageously implemented.

In FIG. 3-A, the electronic device 200 according to the invention is arranged in the premises of an operator, for example a television service broadcaster. In such a situation, the device 200 may either operate as described previously, extracting the management data from the stream F1, or acquire these management data by any other means. The operator in whose premises the electronic device is arranged has in fact management data at its direct disposal, and it can communicate them according to any other means to the decoder without using the stream F1. The transmission 210 then takes place to at least the first decoder 205 advantageously by means of an Internet link.

In FIG. 3-B, the electronic device 200 is represented in the same configuration as in FIG. 2: It is constituted of an independent box which sends, by the transmission 210, the management data required for the change of service to at least one decoder (in the example represented, to the first decoder 205 and to the second decoder 206). The transmission 210 may take place either by an Internet link, or by any other means, notably BlueTooth or Wifi type wireless transmission means.

In FIG. 3-B, the electronic device 200 is integrated in a television decoder 301, known as master decoder. The master decoder is capable, by the transmission 210, of sending the management data required for the change of service to at least one decoder (in the example represented, to the first decoder 205 and to the second decoder 206).

The transmission time of management data between the electronic device 200 according to the invention and a decoder where the change of service operation has to intervene is typically from one millisecond (case where the electronic device 200 is installed in the premises of the user of the decoder) to ten milliseconds (case where the electronic device is installed in the premises of the operator), which is a clear improvement to the situation of the prior art where on average 250 milliseconds are necessary to recover the management data required for the change of service operation.

The method according to the invention is advantageously implemented from the moment the electronic device 200 receives power, and from the moment that it receives the stream of signals F1. The electronic device 200 takes on average ten or so minutes to recover all of the management data of the services available in the stream F1. Once all of the management data has been acquired, their updating, carried out progressively while taking into account the end of programme times, makes it possible to guarantee immediate availability of the management data for the change of service in order to switch from a first service to any other service of the stream F1.

Moreover, the method according to the invention is automatically implemented, that is to say without the intervention of the user on his control means, to carry out a change of service, the memorisation of the management data taking place in an automatic manner, advantageously from the moment that the electronic device according to the invention is supplied with power.

1. A method for changing service of a digital television decoder, said digital television decoder receiving data in the form of a stream of signals composed of a plurality of services and including audio and/or video data and management data of said services, in which an access to a service in response to a service change command requires the digital television decoder to acquire management data of said service, said method comprising:
within an electronic device of management data, memorising a management list before a request to access the service, said management list including at least one first group of management data associated with a first service and a second group of management data associated with a second service;
receiving in the digital television decoder a service change command in order to switch from the first service to the second service;
accessing the second service using the second group of management data stored in the electronic device.

2. The method according to claim 1, further comprising memorising, in the management list, the totality of the management data of the stream of signals.

3. Method The method according to claim 1, further comprising automatically updating of the management list, each memorised group of management data being replaced by an updated group of management data when a programme broadcast by the service, associated with the considered group of management data, changes.

4. The method according to preceding claim 1, wherein automatically updating the management list includes the operation that consist of memorising, for each service for which the management data is memorised, an end of programme information corresponding to a schedule marking the end of the programme broadcast by the considered service at the moment of the memorisation of the management data that are associated therewith.

5. The method according to claim 3, wherein the electronic device of management data includes at least one first receiver chain and a second receiver chain receiving the stream of signals, the receiver chain used for the replacement of a memorised group of management data by an updated group of management data being the receiver chain having been used for such a replacement operation for the longest duration.

6. The method according to claim 1, wherein one of the electronic device of management data is arranged beforehand in the premises of a service broadcaster.

7. The method according to claim 1, further comprising establishing an IP link between the electronic device of management data and the digital television decoder to communicate the second group of management data from the electronic device of management data to the digital television decoder.

8. The method according to claim 1, wherein the electronic device of management data is integrated beforehand in a digital television decoder.

9. The method according to claim 8 further comprising establishing an IP link between the digital television decoder integrating the electronic device of management data and at least one secondary digital television decoder to communicate the second group of management data from the digital television decoder integrating said electronic device to each secondary digital television decoder.

10. An electronic device suited to be used as module for memorising management data in response to a command for changing said service in the method according to claim 1, said device including:
automatic memorisation means in a memory module for memorising a management list before the request to access the service, said management list including at least one first group of management data associated with a first service and a second group of management data associated with a second service;
means of automatic updating of said management list.

11. A digital television decoder equipped with the electronic device according to claim 10.
